(19) United States
(12) Patent Application Publication
(10) Pub. No.: US 2024/0322739 A1
(43) Pub. Date: Sep. 26, 2024

(54) PORTABLE POWER GENERATING ASSEMBLY AND SYSTEM

(71) Applicant: Norberto Galvan, Edinburg, TX (US)

(72) Inventor: Norberto Galvan, Edinburg, TX (US)

(21) Appl. No.: 18/124,087

(22) Filed: Mar. 21, 2023

(51) Int. Cl. H02S 10/40; B62D 63/08; H02J 7/34; H02J 7/35; H02S 10/20

(52) U.S. Cl. CPC H02S 10/40; B62D 63/08; H02J 7/342; H02J 7/35; H02S 10/20; H02J 2207/20

(57) ABSTRACT

A portable power generating assembly and system for generating and storing electricity using a vehicle includes a plurality of solar panels mounting to the vehicle and generating electricity when each of the solar panels is positioned within sunlight. A power supply is electrically coupled to the plurality of solar panels and receives electricity from the plurality of solar panels. The power supply comprises a plurality of batteries in electric communication with each other to define a battery bank.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to electricity generators and more particularly pertains to a new electricity generator for generating and storing electricity using a vehicle.

### (2) Description of Related Art Including Information Disclosed Under 37 CFR 1.97 and 1.98

The prior art relates to electricity generators and includes a variety of electricity generators comprising a plurality of solar panels being mounted to a vehicle. Known prior art does not include the plurality of solar panels storing electricity in a plurality of batteries defining a battery bank.

### BRIEF SUMMARY OF THE INVENTION

An embodiment of the disclosure meets the needs presented above by generally comprising a plurality of solar panels being configured for mounting to the vehicle and generating electricity when each of the solar panels is positioned within sunlight. A power supply is electrically coupled to the plurality of solar panels and receives electricity from the plurality of solar panels. The power supply comprises a plurality of batteries in electric communication with each other to define a battery bank.

Another embodiment of the disclosure comprises a system including a vehicle and a plurality of solar panels being mounted to the vehicle and generating electricity when each of the solar panels is positioned within sunlight. A power supply is electrically coupled to the plurality of solar panels and receives electricity from the plurality of solar panels. The power supply comprises a plurality of batteries in electric communication with each other to define a battery bank.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top isometric view of a portable power generating assembly and system according to an embodiment of the disclosure.

FIG. 2 is a top view of an embodiment of the disclosure.

FIG. 3 is a cross-sectional view of an embodiment of the disclosure taken along Line 3-3 of FIG. 2.

FIG. 4 is a block diagram view of an embodiment of the disclosure.

FIG. 5 is a top isometric view of an alternative embodiment of the disclosure.

FIG. 6 is a top isometric view of an alternative embodiment of the disclosure.

### DETAILED DESCRIPTION OF THE INVENTION

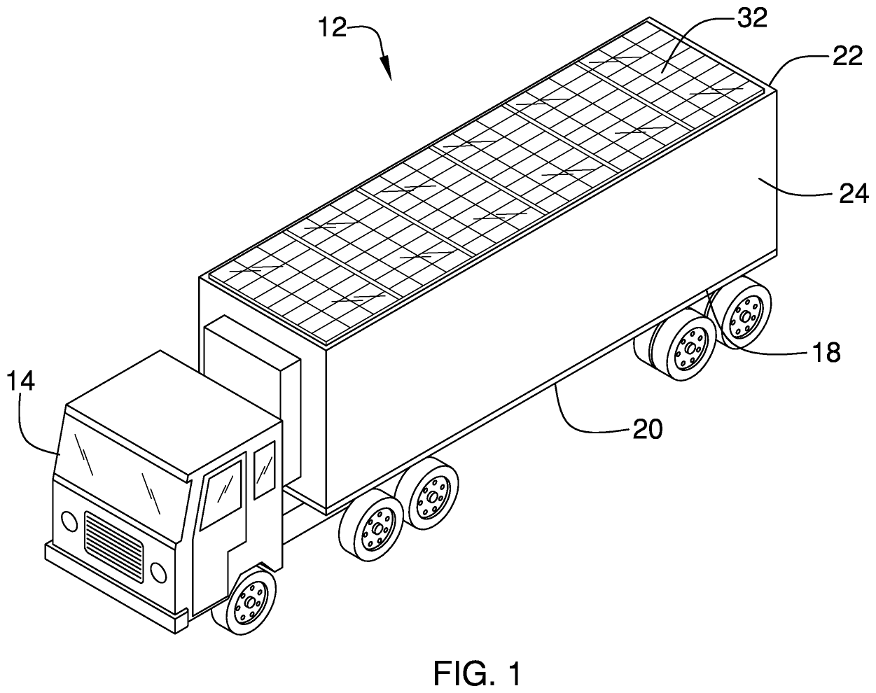

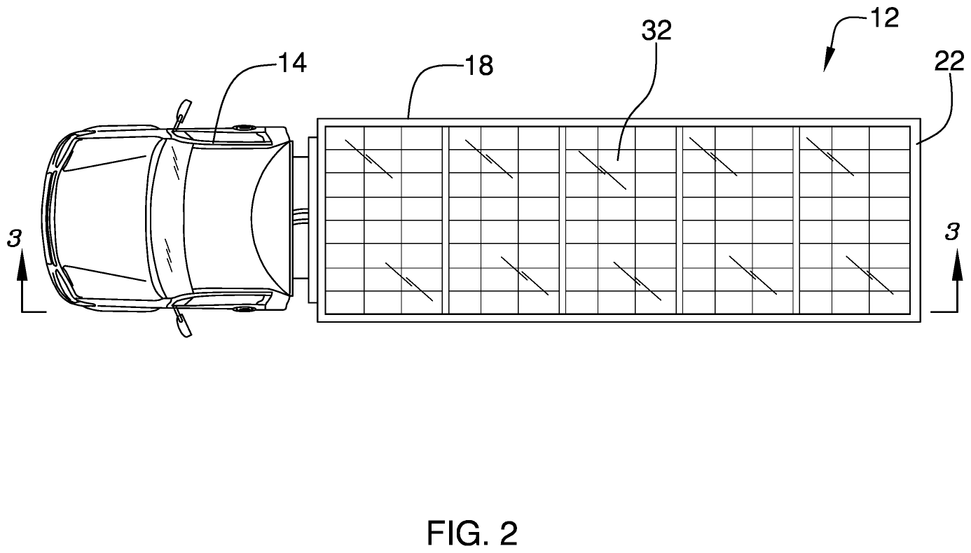

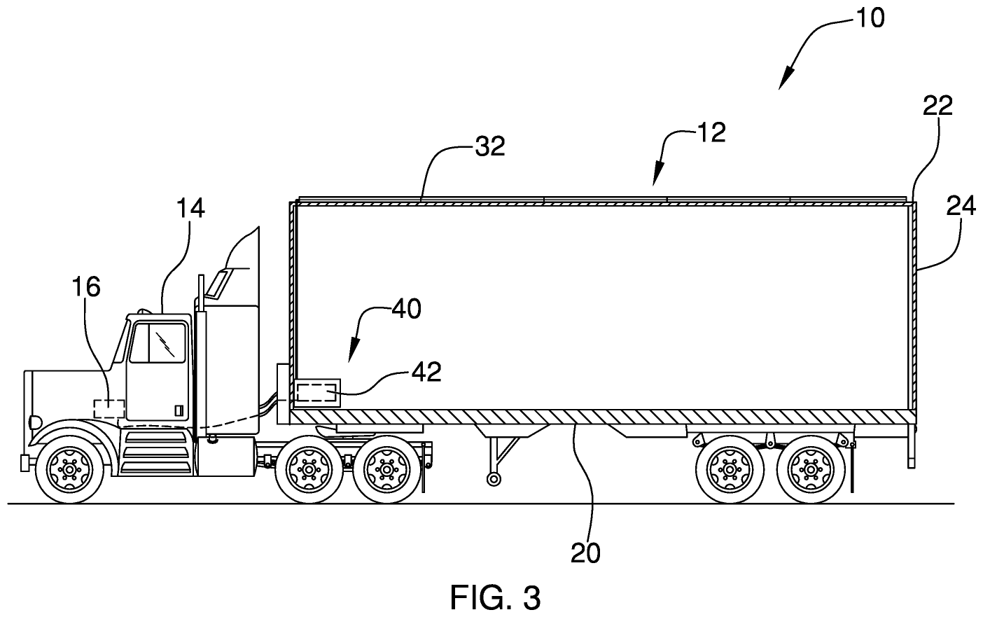

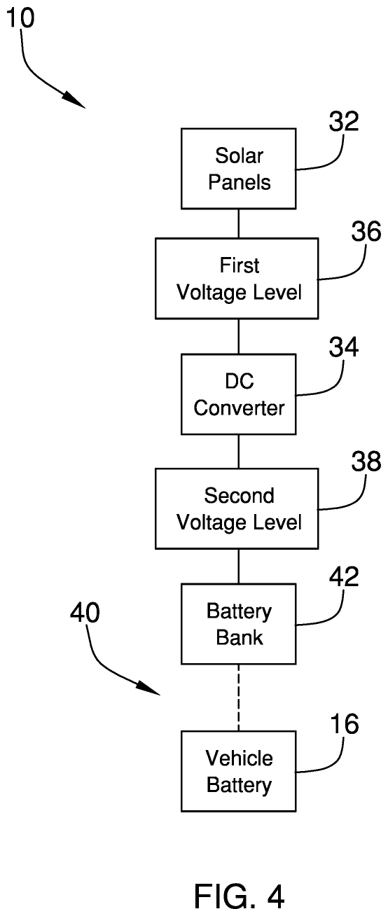

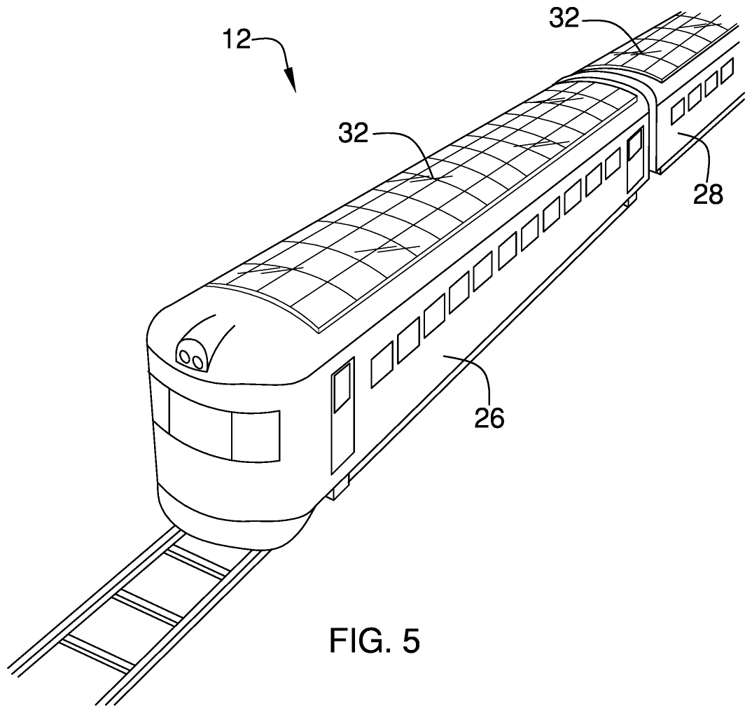

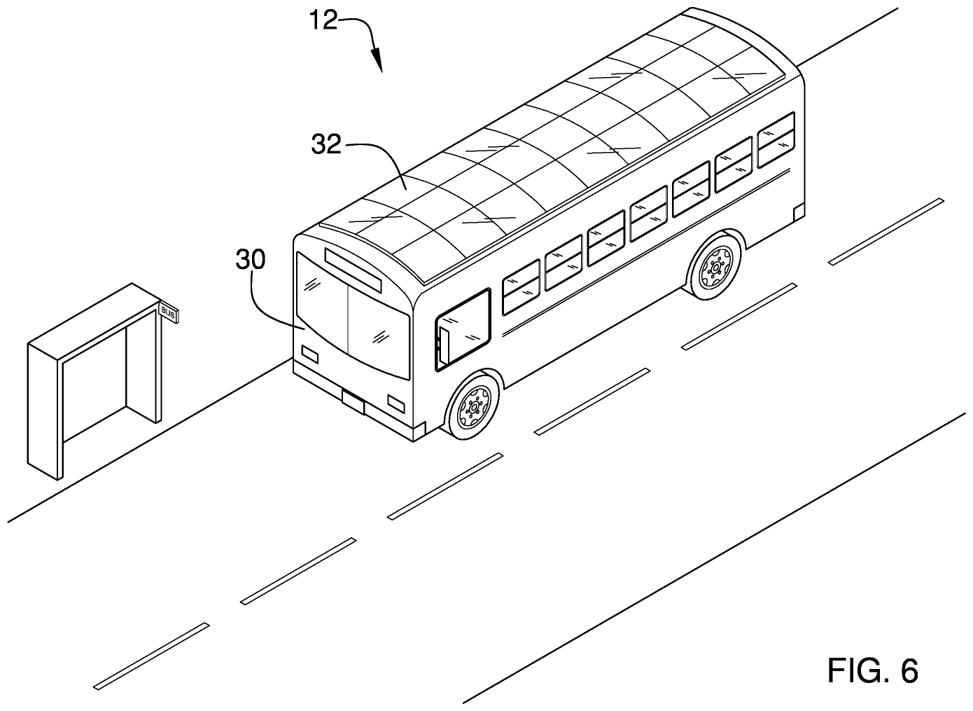

With reference now to the drawings, and in particular to FIGS. 1 through 6 thereof, a new electricity generator embodying the principles and concepts of an embodiment of the disclosure and generally designated by the reference numeral 10 will be described.

As best illustrated in FIGS. 1 through 6, the portable power generating assembly and system 10 generally comprises a vehicle 12. The vehicle 12 typically includes a tractor 14 and a vehicle battery 16 providing electricity to the tractor 14. The vehicle battery 16 is normally positioned within the tractor 14. A trailer 18 is normally pulled by the tractor 14. The trailer 18 includes a bottom wall 20, a top wall 22, and a perimeter wall 24 extending between the top wall 22 and the bottom wall 20. Alternatively, the vehicle 12 may be a locomotive 26 pulling at least one railway car 28 on a railway track. The vehicle 12 may also include an automobile 30 such as a school bus, a car, or any other conventional automobile.

A plurality of solar panels 32 is mounted to the vehicle 12 and generates electricity when each of the solar panels 32 is positioned within sunlight. The plurality of solar panels 32 is typically mounted to the top wall 22 of the trailer 18 configured for being optimal for receiving sunlight relative to the perimeter wall 24 and bottom wall 20 of the trailer 18. The plurality of solar panels 32 may also be mounted on the perimeter wall 24 of the trailer 18 or on the tractor 14. Alternatively, the plurality of solar panels 32 may be mounted to the top of the locomotive 26 and to the top of at least one railway car 28 being pulled by the locomotive 26. The plurality of solar panels 32 may also be mounted to a top side of the automobile 30.

A voltage converter 34 is electrically coupled to the plurality of solar panels 32 to convert electricity generated by the plurality of solar panels 32 from a first voltage level 36 to a second voltage level 38. The first voltage level 36 is higher than the second voltage level 38, wherein the voltage converter 34 is lower the voltage level generated by the plurality of solar panels 32. Alternatively, the first voltage level 36 may be lower than the second voltage level 38, wherein the voltage converter may raise the voltage level generated by the plurality of solar panels 32. The voltage converter 34 is normally positioned within the trailer 18 of the vehicle 12. Alternatively, the voltage converter 34 may be positioned within the locomotive 26 or within at least one of the railway cars 28. The voltage converter 34 may also be positioned within the automobile 30.

A power supply 40 is electrically coupled to the plurality of solar panels 32 and receives electricity from the plurality of solar panels 32. The power supply 40 comprises a plurality of batteries in electric communication with each other to define a battery bank 42. The battery bank 42 may be stored within the trailer 18 of the vehicle 12 or within the tractor 14 pulling the trailer 18. Alternatively, the battery bank 42 may be stored within the locomotive 26 or within at least one railway car 28 pulled by the locomotive 26. The battery bank 42 may also be stored within the automobile 30. The battery bank 42 typically stores the electricity and an electrical receiver may receive electricity from the battery bank 42. Alternatively, the power supply 40 may comprise the vehicle battery 16 of the tractor 14, wherein the solar panels 32 provide power to the vehicle battery 16.

In use, the solar panels 32 mounted to the vehicle 12 are positioned in sunlight as the vehicle 12 travels, wherein the solar panels 32 generate electricity from the sunlight. The voltage converter 34 may be electrically coupled to the solar panels 32 to alter the electricity generated from the solar panels 32 from the first voltage level 36 to the second voltage level 38 prior to storing the electricity within the battery bank 42.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A portable power generating assembly configured for generating electrical power using a vehicle, said portable power generating assembly comprising:
a plurality of solar panels being configured for mounting to the vehicle and generating electricity when each of said solar panels is positioned within sunlight; and
a power supply being electrically coupled to said plurality of solar panels and receiving electricity from said plurality of solar panels, said power supply comprising a plurality of batteries in electric communication with each other to define a battery bank.

2. The portable power generating assembly of claim 1, wherein said plurality of solar panels is configured for mounting to a top surface of the vehicle.

3. The portable power generating assembly of claim 1, further including a voltage converter being electrically coupled to said plurality of solar panels and converting electricity generated by said plurality of solar panels from a first voltage level to a second voltage level, said voltage converter being configured for being positioned within the vehicle.

4. The portable power generating assembly of claim 1, wherein said battery bank is configured for storing within the vehicle.

5. (canceled)

6. A portable power generating system comprising:
a vehicle;
a plurality of solar panels being mounted to said vehicle and generating electricity when each of said solar panels is positioned within sunlight; and
a power supply being electrically coupled to said plurality of solar panels and receiving electricity from said plurality of solar panels, said power supply comprising a plurality of batteries in electric communication with each other to define a battery bank.

7. The portable power generating system of claim 6, wherein said vehicle includes a tractor.

8. The portable power generating system of claim 7, further including a vehicle battery providing electricity to said tractor. said vehicle battery being positioned within said tractor.

9. The portable power generating system of claim 8, further including a trailer being pulled by said tractor, said trailer including a bottom wall, a top wall, and a perimeter wall extending between said top wall and said bottom wall.

10. The portable power generating system of claim 9, wherein said plurality of solar panels is mounted to said top wall of said trailer.

11. The portable power generating system of claim 6, further including a voltage converter being electrically coupled to said plurality of solar panels and converting electricity generated by said plurality of solar panels from a first voltage level to a second voltage level, said voltage converter being positioned within said trailer of said vehicle.

12. The portable power generating system of claim 9, wherein said battery bank being stored within said trailer of said vehicle.

13. The portable power generating system of claim 8, wherein said battery bank being electrically couplable to the vehicle battery of the tractor.

14. A portable power generating system comprising:
a vehicle, said vehicle including:
a tractor;
a vehicle battery providing electricity to said tractor, said vehicle battery being positioned within said tractor; and
a trailer being pulled by said tractor, said trailer including a bottom wall, a top wall, and a perimeter wall extending between said top wall and said bottom wall;
a plurality of solar panels being mounted to said vehicle and generating electricity when each of said solar panels is positioned within sunlight, said plurality of solar panels being mounted to said top wall of said trailer;
a voltage converter being electrically coupled to said plurality of solar panels and converting electricity generated by said plurality of solar panels from a first voltage level to a second voltage level, said voltage converter being positioned within said trailer of said vehicle; and
a power supply being electrically coupled to said plurality of solar panels and receiving electricity from said plurality of solar panels, said power supply comprising a plurality of batteries in electric communication with each other to define a battery bank, said battery bank being stored within said trailer of said vehicle, said battery bank being electrically couplable to the vehicle battery of the tractor.
